(19) United States
(12) Patent Application Publication
(10) Pub. No.: US 2025/0297451 A1
(43) Pub. Date: Sep. 25, 2025

(54) Electric Construction Machine

(71) Applicant: Wacker Neuson Produktion GmbH & Co. KG, Relchertshofen (DE)

(72) Inventors: Markus Falzberger, Pupping (AT); Paul Obemdorfer, Lambach (AT)

(21) Appl. No.: 19/086,891

(22) Filed: Mar. 21, 2025

(30) Foreign Application Priority Data
Mar. 25, 2024 (EP) 24165897

(51) Int. Cl. E02F 9/08; B60L 50/60; B60L 53/16; E02F 9/20

(52) U.S. Cl. CPC E02F 9/0866; B60L 50/60; B60L 53/16; E02F 9/2091; B60L 2200/40

(57) ABSTRACT

An electric construction machine is provided of the type that has an electric drive train and/or an electric working unit. The machine includes an electric energy storage device for supplying the construction machine with electrical energy, and a charging device for charging the energy storage device. The charging device is arranged above the electric energy storage device in a drive compartment which can be closed by a cover. In order to achieve advantageous maintenance conditions, a bracket is arranged in the drive compartment above the electric energy storage device, which bracket comprises a drawer guide for a frame of the charging device. The frame may include slide-in guides for charging interface modules.

### BACKGROUND

### 1. Field of the Invention

The invention relates to an electric construction machine comprising an electric drive train and/or electric working unit, with an electric energy storage device for supplying the construction machine with electrical energy and with a charging device for charging the energy storage device, wherein the charging device is arranged above the electric energy storage device in a drive compartment, which can be closed by a cover.

### 2. Discussion of the Related Art

Electrically powered construction machines comprise a rechargeable battery as an energy storage device, which is used to operate various electric motors and supply consumers. To charge the rechargeable battery, a plug socket is provided on the machine, to which socket a charging cable can be connected. Depending on the customer, there are different requirements with regard to the desired charging power, which requires the installation of a wide variety of charging devices. Cramped spatial conditions in drive compartments brought about by the large batteries lead to severe restrictions in the available installation space, whereby access to components in the case of repairs or servicing, as well as during installation, is considerably more difficult. A subsequent installation of charging devices with a higher charging power is therefore associated with considerable obstacles.

For confined construction site applications, efforts are being made to produce construction machinery that is as compact as possible. Electric construction machines without rear overhang, such as zero tail excavators are already known from the state of the art, such as EP4306724A1. To ensure that the superstructure of the construction machine is sufficiently compact, the axis of rotation of the electric motor and the longitudinal axis of the hydraulic pump are arranged parallel to a vertical axis, which is to say, vertically. In this way, the height of the superstructure can be taken advantage of to the benefit of a compact length and width of the superstructure. The disadvantage thereof, is, however, that this results in restrictions with regard to the unrestricted orientation of the electric motor and the hydraulic pump, which can lead to the need of special designs of these components and complex contacting and routing of the hydraulic lines.

The invention is thus based on the task of creating a device of the aforementioned type, which allows improved accessibility to components installed in the drive compartment in the event of repair or servicing, as well as simple retrofitting of components.

### SUMMARY

The invention solves the framed task in that a bracket is arranged in the drive compartment above the electric energy storage device, which bracket comprises, which is to say bears or forms, a drawer guide for a frame of the charging device. The frame may include at least one, and possibly two or more slide-in guides for charging interface modules.

This provides improved accessibility to components installed in the drive compartment for repairs or servicing when the frame with the charging interface module(s) is extended out of the working space, since a free working space opens up with an extended frame. In the extended position, the extended frame can thus, if necessary, be swiveled upwards out of the slide-in area, and thereby open up the slide-in opening for free access. A removal of the extended frame is also possible after disconnecting electrical connections, especially plugs. Components installed in the frame, such as charging interface modules, can be easily replaced or alternatively retrofitted. The charging power can be adjusted with the number of charging interface modules installed in the frame. The frame can accommodate a fuse box and a charging socket. The charging interface modules may comprise chargers and charging controllers.

There may be an at least partial, and more typically complete, overlapping of projection surfaces of the energy storage device and of the frame, which surfaces project in the direction of a vertical axis. This configuration allows for good access to other components installed in the drive compartment for repairs or servicing when the frame is extended out of the drive compartment.

The charging interface modules can be grounded to the frame. For this purpose, it is possible, in the assembled state, to make a screw connection of components arranged in the frame, such as in particular charging interface modules, to the frame. Grounding cables, sliding contacts or plug connections can also be provided for this purpose between the components and the frame, which frame forms, in particular a grounded cage for components arranged in it.

Similarly, the frame can be grounded to the bracket and thereby to a body of the construction machine. In order to ensure particularly robust conditions and, as a result of rough construction site operation, also a secure locking of the frame to the bracket, the frame inserted into the drive compartment can be securely connected to the bracket, and possibly to the drawer guide, by means of at least one screw connection forming a ground connection. After loosening the screw connection of the frame and bracket, for example, two screws in the area of the front of the frame, the frame can be pulled out of the drive compartment along the drawer guide.

The frame may be at least partially open towards the energy storage device, and cooling surfaces of the charging interface modules may be arranged in this open area, which cooling surfaces connect to a cooling air duct provided between the energy storage device and the frame. In this way, the waste heat from the energy storage device and charging interface modules, which are, for example, equipped with cooling surfaces facing downwards towards the energy storage device, can be transported out of the drive compartment by means of a common ventilation device.

A panel can, for example, be assigned to the frame in the area of the front of the frame, which panel accommodates a charging connection socket and a charging level indicator. If this panel overlays the frame on the rear side when in a use position and if the panel is pivotably mounted on the frame in such a way that the charging interface modules are freely accessible in a maintenance position pivoted away from the use position, this results in particularly compact construction conditions. A storage space can be provided behind the panel to accommodate a charging cable. Operating elements for the charging process of the machine and display elements for the charging status of the rechargeable battery can be integrated into the panel.

In addition to the at least two slide-in guides for charging interface modules, the frame can comprise at least one slide-in guide for a fuse module and/or a power distributor.

The charging interface module and, if necessary, a fuse module can have electrical plug connections which, in the inserted state, are plugged into correspondingly opposing plug connections on the frame.

The invention achieves a frame in which there is a compact arrangement of modular expandable electrical components, such as charging interface modules, but also fuse modules and/or power distributors and, if necessary, operating elements for the charging process. The frame forms a compact unit which, by loosening one or a few securing devices such as screws or the like, greatly improves the accessibility to components that are permanently installed in the drive compartment, by allowing a drawer guide to move an entire assembly arranged in the frame in a linear manner. In so doing, this greatly simplifies the replacement or exchange of components and allows the components installed in the frame to be integrated into the thermal management of the construction machine.

### BRIEF DESCRIPTION OF THE DRAWINGS

The subject matter of the invention is shown as an example in the drawings, in which:

FIG. 1 is a partially cutaway rear view of an electric construction machine,

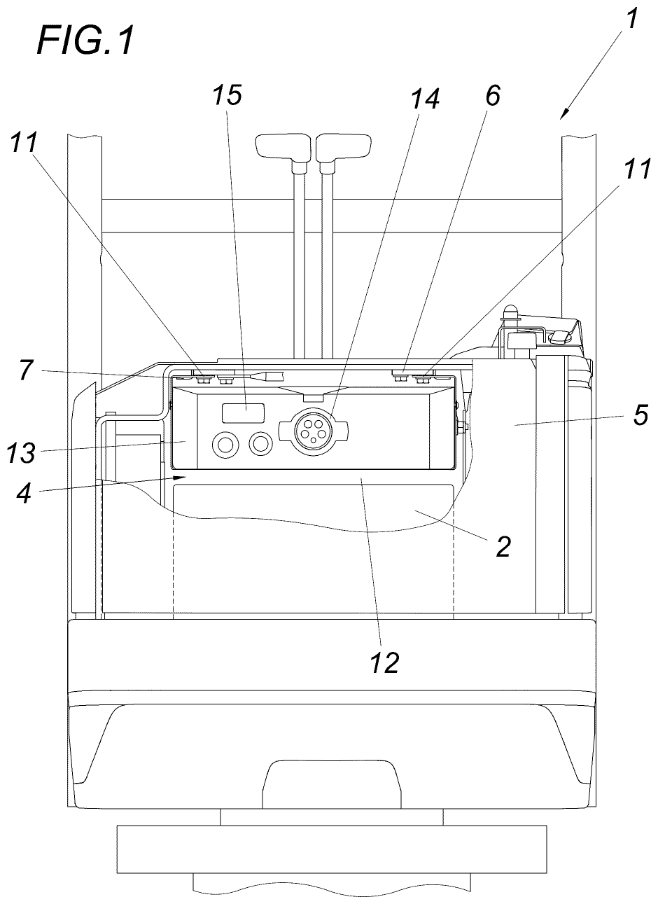

FIG. 2 is an oblique view of the bracket and frame, and

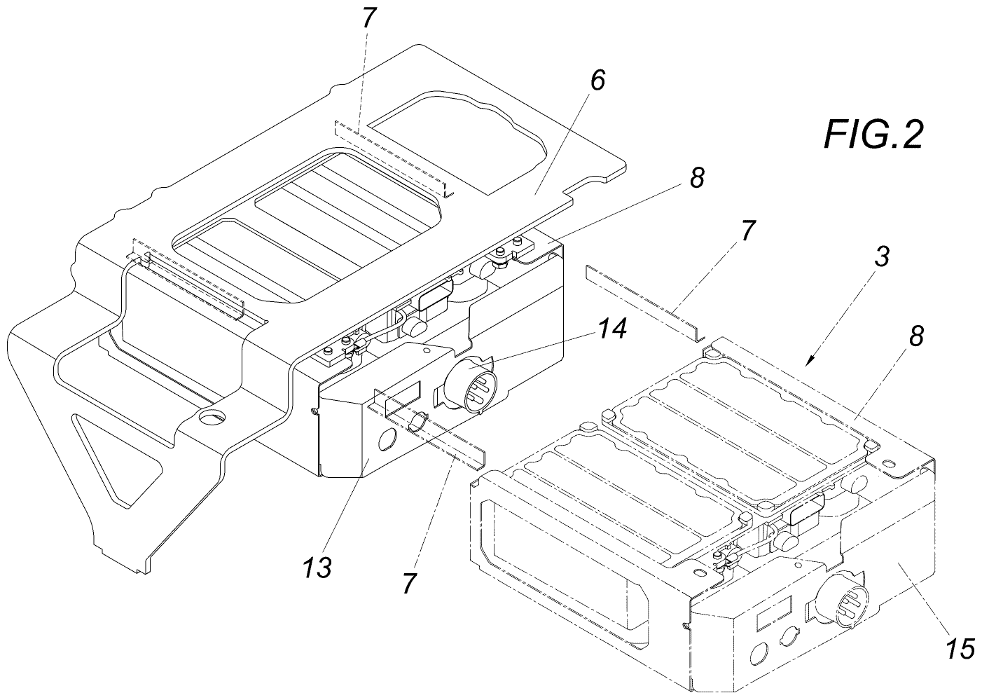

FIG. 3 is an oblique view of the frame and charging interface module.

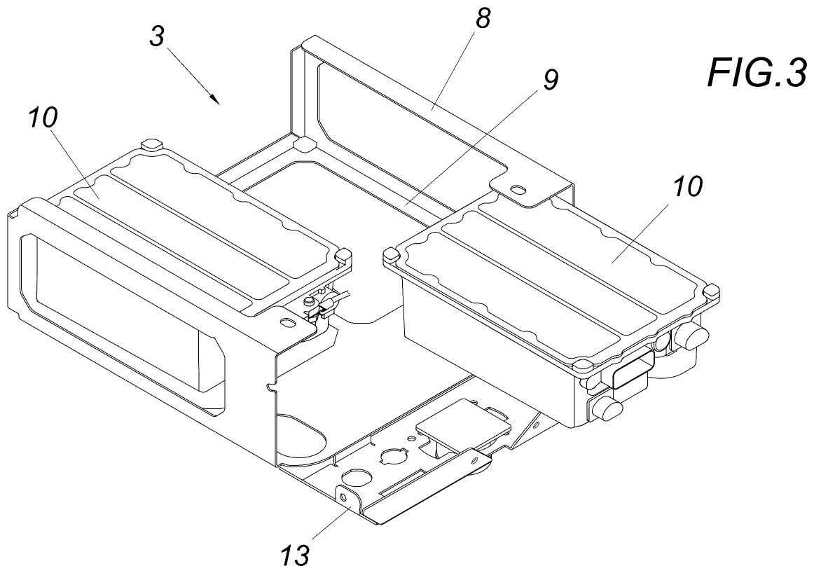

### DETAILED DESCRIPTION

The electric construction machine 1 with an electric drive train and/or electric working unit, comprises an electric energy storage device 2 for supplying the construction machine 1 with electrical energy and comprising a charging device 3 for charging the energy storage device 2, wherein the charging device 3 is arranged above the electric energy storage device 2 in a drive compartment 4, which can be closed with a cover 5. A bracket 6 is arranged in the drive compartment 4 above the electric energy storage device 2, which bracket comprises a drawer guide 7 for a frame 8 of the charging device 3, wherein the frame 8 comprises slide-in guides 9 for charging interface modules 10.

The projection surfaces of the energy storage device 2 and of the frame 8 that project in the direction of a vertical axis overlap each other, at least in sections, and, in the embodiment example shown, overlap completely. The energy storage device 2 and frame 8 could also be offset slightly to the side.

The charging interface modules 10 are grounded to the frame 8 by means of screws, cables, sliding contacts or plug connections and are fastened in the frame 8 using suitable means. In turn, the frame 8 is grounded to the bracket 6 and thereby to a body of the construction machine 1. In the embodiment example, the frame 8 inserted into the bracket 6 or into the working space 4 is securely connected to the bracket 6 by means of at least one screw connection 11 forming a ground connection.

The frame 8 is at least partially open at the bottom towards the energy storage device 2. Cooling surfaces of the charging interface modules 10 are arranged in this open area, which cooling surfaces connect to a cooling air duct 12 provided between energy storage device 2 and frame 8. In the embodiment example, at least the charging interface module base forms cooling surfaces.

A panel 13 is assigned to the frame 8, which panel accommodates a charging connection socket 14 and a charging level indicator 15. The panel 13 can overlay the frame 8 on the rear side when in a use position and can be pivotably mounted on the frame 8 in such a way that the drive compartment 4 is freely accessible in a maintenance position.

1. An electric construction machine, comprising:
an electric drive train and/or an electric working unit;
an electric energy storage device for supplying the construction machine with electrical energy;
a charging device for charging the energy storage device, wherein the charging device is arranged above the electric energy storage device in a drive compartment, which can be closed by a cover; and
a bracket which is arranged in the drive compartment above the electric energy storage device, the bracket comprising a drawer guide for a frame of the charging device.

2. The electric construction machine according to claim 1, wherein he frame comprises slide-in guides for charging interface modules.

3. The electric construction machine according to claim 1, wherein the energy storage device and the frame have projection surfaces that project in a direction of a vertical axis so as to overlap each other, at least in sections.

4. The electric construction machine according to claim 1, wherein the energy storage device and the frame have projection surfaces that project in a direction of a vertical axis so as to completely overlap each other.

5. The electric construction machine according to claim 2, wherein the charging interface modules are grounded to the frame.

6. The electric construction machine according to claim 1, wherein the frame is grounded to the bracket and, thereby, to a body of the construction machine.

7. The electric construction machine according to claim 6, wherein the frame is securely connected to the bracket via at least one screw connection forming a ground connection.

8. The electric construction machine according to claim 1, wherein the frame is at least partially open towards the energy storage device, and wherein cooling surfaces of the charging interface modules are arranged in this open area, which cooling surfaces connect to a cooling air duct provided between the energy storage device and the frame.

9. The electric construction machine according to claim 1, wherein a panel is assigned to the frame, which panel accommodates a charging connection socket and a charging level indicator.

10. The electric construction machine according to claim 9, wherein the panel overlays the frame on a rear side in a position of use thereof, and wherein the panel is pivotably mounted on the frame in such a way that the charging interface modules are freely accessible in a maintenance position.

11. The electric construction machine according to claim 1, wherein the frame comprises at least one slide-in guide for a fuse module and/or a power distributor.

12. The electric construction machine according to claim 1, wherein the charging interface module and a fuse module have electrical plug connections which, in the inserted state, are plugged into correspondingly opposing plug connections on the frame.
